(19) United States
(12) Patent Application Publication
(10) Pub. No.: US 2020/0302820 A1
(43) Pub. Date: Sep. 24, 2020

(54) PERSONALIZED ELECTRONIC EDUCATION

(71) Applicant: Great Explanations Foundation, Westport, CT (US)

(72) Inventor: Lawrence SHERMAN, Westport, CT (US)

(21) Appl. No.: 16/894,580

(22) Filed: Jun. 5, 2020

Related U.S. Application Data
(63) Continuation-in-part of application No. 13/595,664, filed on Aug. 27, 2012, now abandoned.

(51) Int. Cl. G09B 7/02; G09B 5/10; G09B 5/12

(52) U.S. Cl. CPC G09B 7/02; G09B 5/12; G09B 5/10

(57) ABSTRACT

Systems and methods implementing on-line learning including determining a concept from a set of stored concepts, the concept associated with a first explanation entry data matrix including a plurality of data fields populated with characteristics of a first explanation and the concept; associating a plurality of users with similar learning profiles based on a correlation metric with the first explanation entry; forming two test groups including a postulate explanation group and a hypothesis group; providing remote access to the first explanation to the postulate explanation group via a first plurality of client devices; delivering an assessment to both the postulate explanation group and hypothesis group; and comparing the results of the assessment outcomes to calculate a success metric indicating a relative strength of the first explanation compared to the second explanation and storing the success metric as part of the first explanation entry data matrix.

### CROSS REFERENCE TO RELATED APPLICATIONS

This application is a Continuation-in-Part of U.S. patent application Ser. No. 13/595,664, filed Aug. 27, 2012, entitled “PERSONALIZED ELECTRONIC EDUCATION” the content of which is incorporated herein in its entirety.

### BACKGROUND

Traditional teaching materials such as textbooks are very costly. Teaching materials can also easily become out of date, may be hard or expensive to distribute, and become damaged or worn out. Additionally, writing a textbook is a significant effort that is frequently undertaken by a single or small number of authors, which can result in a limited viewpoint on the subject. Thus, a student may be restricted to a single uniform style of teaching provided by the textbook. In addition, because of the effort involved in writing a textbook as well as the expense, textbooks may not be frequently updated. And, even if the textbook is updated, the new versions may not be purchased frequently.

A single textbook for a subject or concept may force students in a class into the same schedule regardless of their needs. If a student does not understand the single source of explanation for a concept in the textbook, the student may miss the concept and fall behind in the subject. A single textbook also assumes a same level of background by all students using the textbook. Students may be bored and disinterested if a text is too rudimentary, or lost if foundational knowledge, which the student lacks, is omitted from the textbook.

In view of the foregoing, it is apparent that there are significant problems and shortcomings associated with current educational material development and delivery.

### SUMMARY

The present disclosure is directed to systems and methods for implementing on-line learning, including determining a concept from a set of stored concepts within a server based on a concept identifier from a sequence of concept identifiers associated with a curriculum template, the concept associated with a first explanation entry data matrix, the first explanation entry data matrix including a plurality of data fields populated with characteristics of a first explanation and the concept; retrieving a learning profile from a set of stored learning profiles using a learning profile data matrix, the learning profile associated with the first explanation entry data matrix based on a correlation between the learning profile data matrix and the first explanation entry data matrix, the learning profile data matrix including the concept identifier from the sequence of concept identifiers associated with the curriculum template; and associating, within a server, a plurality of users associated with the learning profile data matrix based on a correlation metric between the concept identifier of the first explanation entry and the learner profile indicated by the relative position of the data fields within the first explanation entry data matrix and the learning profile data matrix. In some embodiments, the systems and methods may include assigning the plurality of users automatically to at least two test groups including a postulate explanation group and a hypothesis group; providing remote access to the first explanation to the postulate explanation group via a first plurality of client devices; retrieving an assessment from an assessment data server associated with the concept based on the concept identifier stored as part of assessment metadata, the assessment including at least one probative question directed to the concept identifier; providing the assessment for completion to the postulate explanation group via a second output on the plurality of client devices and automatically generating a postulate group outcome for the assessment indicated by a first percentage of correct responses to the assessment; determining, by the processor, a second explanation entry data matrix for a second explanation entry associated with the concept based on the concept identifier; providing remote access to the second explanation entry to the hypothesis group via a second plurality of client devices; and providing the assessment for completion to the postulate explanation group via a second output on the plurality of client devices and determining a hypothesis group outcome for the assessment indicated by a second percentage of correct responses to the assessment. In yet other embodiments, the systems and methods may include comparing the results of the assessment outcomes indicated by the first percentage and the second percentage to calculate a success metric indicating a relative strength of the first explanation as compared to the second explanation and storing the success metric as part of the first explanation entry data matrix; ranking the first explanation and second explanation in an explanation database based on the success metric or identifying one of the first explanation and the second explanation as a preferred explanation for the learning profile based on the success metric. Through the use of explanation data and learning profile data matrices, the data structures implemented as part of the disclosure herein facilitate improved online learning and correlations between predictive variables relevant to online learning.

In some embodiments, the success metric includes a confidence interval based on a number of times that the first explanation has been assigned to the postulate explanation group. In other embodiments, at least one of the plurality of learning profiles includes information indicative of the characteristics, including at least one of prior knowledge of at least one of the plurality of users; a preferred language of at least one of the plurality of users; a preferred cultural background of at least one of the plurality of users; a level of interest of at least one of the plurality of users in a subject; a known familiar context of at least one of the plurality of users; an ability of at least one of the plurality of users to learn new concepts in a particular discipline; a favored style of learning of at least one of the plurality of users; a chronological age of at least one of the plurality of users; and an academic age of at least one of the plurality of users. In some embodiments, performing the assessment of at least one of the plurality of students includes at least one of: identifying a priori knowledge for the set of concepts; identifying gaps in a priori knowledge of the at least one of the plurality of students associated with the set of concepts; and supplementing explanation information to address identified knowledge deficits. In some embodiments, the concept identifier represents a categorical determination selected by a submitter.

A system and computer implemented method for generating and delivering personalized electronic education. Techniques can include identifying and dividing a learning concept into a plurality of portions and assessing a student to determine a knowledge deficit of the student associated with the learning concept. The techniques can include defining a learning profile for a student, receiving multiple explanation submissions based on a student's unique learning profile (e.g., for that concept because a student may have a different learning profile for different subjects such as math and language arts), and evaluating one or more of the multiple explanation submissions for each concept portion based on an understanding of the concept by students after presentation of the one or more of the multiple explanation submissions for each concept portion. Evaluation can be performed automatically by gathering feedback of understanding of the concept using a sample of students with a similar learning profile. At least one of the multiple explanation submissions can be identified and ranked based on the evaluation. Explanations can be identified that work for some students with certain learning profiles, but not for those students with other learning profiles. Questions and/or answers can be identified that may work for students with certain learning profiles but not for students with other learning profiles. Answers can be structured and fine-tuned to reveal slight misunderstandings or even the depth of understanding of a concept to allow evaluation and relative ranking of how well students understand a concept (e.g., thus allowing an organization that must interview large numbers of applicants to end up with a more sophisticated ranking of the applicants). Each student can learn at his or her own pace and can see the very best explanation for their learning profile for that particular concept.

A student can select a button on an interface and immediately communicate with a tutor/helper certified for that particular student's learning profile and that concept. The student can also review material as often as he wants and go back and fill-in gaps in his knowledge. All in private and without fear of embarrassment; and with no social or personal pressure. A student can review material as often as they want to fill in gaps in their knowledge.

In general, in an aspect, embodiments of the invention can provide, a semi- or fully-automatic computer-implemented method for personalized electronic education of a student, the method including, performing a computerized assessment of the student, using a knowledge assessment module, to determine a knowledge deficit of the student associated with at least one concept, defining a learning profile for the student using a learning profile generation module, receiving, at a server module, a computerized explanation submission based on the learning profile, evaluating, using an explanation submission evaluation module of the server module, the received explanation submission based on an understanding of the concept by the student after presentation to the student of the explanation submission, and rating, using the explanation submission evaluation module, the explanation submission based on the evaluation.

Implementations of the invention can include one or more of the following features. The explanation is retrieved or received from an available source. The method includes receiving an explanation submission from a pre-qualified or random source. The method includes learning profile information indicative of at least one of prior accumulated knowledge that has been mastered and remembered by the student, a preferred language of the student, a preferred cultural background of the student, a level of interest of the student in a subject, known familiar contexts of the student, an ability of the student to learn new concepts in a particular discipline, a favored style (or styles) of learning of the student, a chronological age of the student, and an academic age of the student. The assessment of the student includes at least one of identifying a priori knowledge for the concept, identifying gaps in a priori knowledge of the student associated with the concept, and supplementing explanation information to address identified knowledge deficits. The method further includes presenting an explanation submission electronically to the student, and synchronizing the electronically presented explanation submission with a lesson plan of the student. The method further includes measuring an understanding of the concept by a plurality of students. The evaluating the explanation submission includes evaluating based at least in part on a number of explanations submitted for a particular concept and a particular learning profile. The method further includes editing the explanation submission prior to evaluating the explanation submission.

In general, in another aspect, embodiments of the invention can provide a computer-implemented method for automatically evaluating electronic education material, the method including receiving, at a server module, electronic explanation submissions of a concept, the electronic explanation submission developed according to a learning profile, presenting, using an explanation submission evaluation module of the server module, the electronic explanation submissions to a first plurality of students, presenting, using an explanation submission evaluation module of the server module, a control electronic explanation of the concept to a second plurality of students, the control electronic explanation developed according to the learning profile, testing the first plurality of students to determine a level of understanding of the concept after presentation of the electronic explanation submission, testing the second plurality of students to determine a level understanding of the concept after presentation of the control electronic explanation, comparing after the testing, using the explanation submission evaluation module, the level of understanding of the concept by the first plurality of students with the level of understanding by the second plurality of students, and rating, using the explanation submission evaluation module, the explanation submission based on the comparison.

Implementations of the invention can include one or more of the following features. The control explanation and the electronic explanation submissions are presented as one of a double-blind test and a blind test. The rating is further based on a popularity of the electronic explanation submission with the first plurality of students. The rating is further based at least in part on a reputation of a source of the electronic education explanation. The method further includes classifying, using the server module, an electronic explanation submission as a verified explanation based upon the rating.

In general, in yet another aspect, embodiments of the invention can provide a system for personalized electronic education including one or more processors communicatively coupled to a network wherein the one or more processors are configured to assess a student to identify a knowledge deficit of the student associated with a concept portion, define a learning profile for the student based on at least one of testing of the student and self-selection, receive an explanation submission based on the learning profile, evaluate the explanation submission based on an understanding of the concept portion by the student after presentation of the explanation submission to the student, and rate the explanation submissions based on the evaluation.

Implementations of the invention can include one or more of the following features. The explanation submission includes receiving a crowdsourced explanation submission. The explanation submission includes receiving an explanation submission from a pre-qualified source. The learning profile includes information indicative of at least one of, prior knowledge of the student, a preferred language of the student, a preferred cultural background of the student, a level of interest of the student in a subject, a known familiar context of the student, an ability of the student to learn new concepts in a particular discipline, a favored style of learning of the student, a chronological age of the student, the student's zip code, and an academic age of the student, among others. Assessing the student includes at least one of identifying a priori knowledge for the concept portion, identifying gaps in a priori knowledge of the student associated with the concept or concept portion, and supplementing explanation information to address identified knowledge deficits. The system further includes possibly editing the explanation submission prior to evaluating the explanation submission.

While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE FIGURES

FIG. 1 is a system diagram of an exemplary computer implemented personalized education generation and delivery system, according to some embodiments of the present disclosure.

FIG. 2 is a system diagram of an exemplary portion of the system shown in FIG. 1, according to some embodiments of the present disclosure.

FIG. 3 is an exemplary operational flow chart for a computer implemented personalized education generation and delivery system, according to some embodiments of the present disclosure.

FIG. 4 is an exemplary operational flow chart for a computer implemented personalized education evaluation system, according to some embodiments of the present disclosure.

FIG. 5 is an exemplary operational flow chart for a computer implemented personalized education evaluation system, according to some embodiments of the present disclosure.

FIG. 6 is an exemplary operational flow chart for a computer implemented personalized education system to adjust an adaptive concept learning profile, according to some embodiments of the present disclosure.

FIGS. 7-11 are exemplary user interface presentations for a computer implemented personalized education system displaying an adaptive concept learning profile, according to some embodiments of the present disclosure.

### DETAILED DESCRIPTION OF PREFERRED EMBODIMENTS

Embodiments of the present disclosure provide systems and methods for implementing personalized education generation, evaluation, and delivery. For example, electronic education material can be crowdsourced or outsourced to a group of people for production. Crowdsourcing can be online and/or offline. For example, a subject can be broken down into discrete concepts, and a concept can be broken down into concept portions. A computer system can advertise requests for people (e.g., subject matter experts) to provide explanations and/or education material relating to the subjects, concepts, and/or concept portions (e.g. based on a request from a specific user). Explanation submissions can be received in response to the advertisements and can be evaluated based on independent review or metrics evidencing student mastery of the concept portions. The specificity of a concept portion may be different for individual users, for example, depending on each school and the level of sophistication of the assumed “typical” student. Each concept is the minimum specific knowledge that a student in his or her class is expected to master. For purposes of description, “mastery” of a concept portion can represent a threshold percentage of correct answers on a standardized assessment, a threshold measurement of improvement as compared to previous scores on a standardized assessment, or other threshold comparison values determined by a system operator. As discussed in further detail below, the crowdsourcing of explanation submissions and the automatic curation of received explanation submissions can provide electronic education materials that can be personalized by a learning profile of an individual student or group of students.

Other embodiments of the present disclosure provide for systems and methods for determining and adjusting an adaptive learning profile for users. The adaptive learning profile may account for variables indicative of a user's learning style or modalities, including languages spoken, a user's micro-culture, chronological age, maturation age, academic subject area ages, pre-requisite knowledge, as well as a user's likes and dislikes, interests, friends, and location data. In addition, the adaptive learning profile may be tailored to specific identified concepts or subject matters (i.e., a “concept learning profile” or “CLP”) to account for differing learning styles or modalities for the same user across subject areas. As described in further detail below, a user's concept learning profile may be adapted in response to outcomes of mastery assessments following explanations of relevant material, indicating a preferred modality or learning style for a specified concept or subject matter.

The user's concept learning profile may also be informed by a user's interaction outside of an assessment platform, including data mining from a user's online persona through professional and social media accounts as well as consumer activity. Employing a user's concept learning profile, in some embodiments, the system is able to adaptively select preferred explanations for the user, based on an “improved concept learning profile” to improve the likelihood that he or she masters the selected concept. An improved concept learning profile may include up-to-date individual characteristics which are constantly changing with time and may differ depending on the area of knowledge and the specific concept and concept portion. To begin adaptively associating a concept learning profile with a user, the system may include a postulate concept learning profiles based on answers from a user to a learner questionnaire and/or inputs to a website, app or game. In some embodiments, explanations may be ranked, such that a single explanation may be the highest rank. When a user is presented with that highest-ranked explanation, the user may or may not master the concept. If the highest-ranked explanation, based on a user's concept learning profile fails to provide student mastery, then the second-ranked CLP-explanation will be served. If the student again fails at mastery after the second-ranked explanation, an analysis of the testing results from both the first and second explanations will be run that includes evaluating results of the testing analysis will reveal which component sub-parts of the concept were grasped, and which were not understood by the user. The system may further evaluate correlations with previously tested learners and control groups (e.g., similar entry CLPs with failure on same sub-components) and determine which factor-weights will be utilized for new-CLP assignment, including academic grade-level (e.g., measured by 0.5 point gradations), learning dexterity (e.g., the speed of learning), secondary languages understood, micro-culture dialects and metaphors, hobbies/avocations, like-topic CLP profiles, recently mastered concepts, and new word additions, among others. In some embodiments, a third explanation can be presented to the user which will inform the user's concept learning profile and may be determined to be the first-ranked explanation in the new CLP assignment. For future iterative attempts at additional explanations, whether successful or not, the user's CLP is recalibrated—and the newly assigned CLP will be reflective of the successful adjustments to CLP of previous learners with similar CLPs, as set by a system administrator or algorithm. For example, a threshold may be set when approximately 20 learners with similar CLPs have failed on the given concept with the given explanation. The system may repeat this process for an individual learner until mastery is achieved. The explanation which ultimately provides subsequent concept mastery will provide strong correlative evidence for the learner's new CLP designation. Each CLP recalibration will factor in past concepts mastered, attempted and failed and subsequently mastered—as well as the new words, concepts, metaphors, modalities, and styles will be added to said learner's lexicon of knowledge.

In some embodiments, the relationship between a user's improved concept learning profile and the explanation received is dependent upon a learner's ability to learn a concept from a provided explanation, determined by how closely the explanation fits what a user already knows and how that user most readily acquires understanding. Although describing embodiments in the field of education, the teachings of this disclosure may apply equally to other embodiments within the scope of the invention including other forms of personal interaction between entities over distributed networks. Therefore, reference to “students” and “users” are used interchangeably throughout.

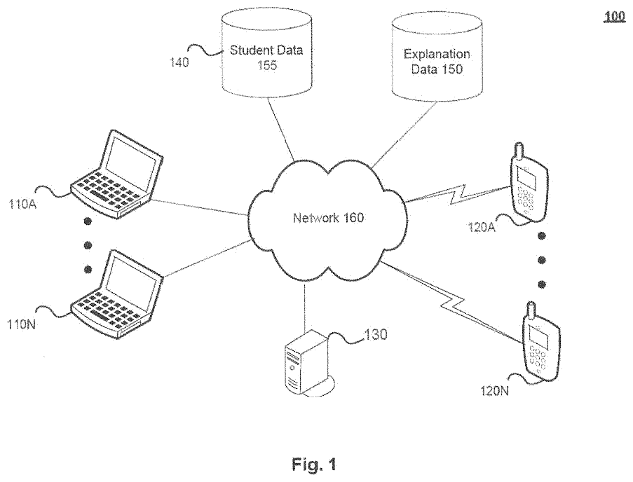

Referring to FIG. 1, an exemplary personalized electronic education system 100 is shown. System 100 can contain client systems 110, 120 and server 130, which can be communicatively coupled to network 160 via a wired and/or wireless network connection. In general, the clients 110A-110N and 120A-120N, and server 130 can include a processor, memory, display device, and operating system software such as Microsoft Windows®, iOS®, Linux, or the like. FIG. 1 is a simplified view of system 100, which can include additional elements that are not depicted such as routers, gateways, additional servers, etc.

Network 160 can be a local area network (LAN), a wide area network (WAN), the Internet, cellular network, satellite network, or other networks that permit communication between clients 110, 120, server 130, and other devices communicatively coupled to network 160. Network 160 can further include one, or any number, of the exemplary types of networks mentioned above operating as a stand-alone network or in cooperation with each other. Network 160 can utilize one or more protocols of one or more clients or servers to which they are communicatively coupled. Network 160 can translate to or from other protocols to one or more protocols of network devices. Although network 160 is depicted as one network, it should be appreciated that according to one or more embodiments, network 160 can comprise a plurality of interconnected networks.

Electronic Storage 140 and 150 can be network accessible storage and can be local, remote, or a combination thereof to server 130 and clients 110A-110N and 120A-120N. Electronic Storage 140 and 150 can, for example, utilize a redundant array of inexpensive disks (“RAID”), magnetic tape, disk, a storage area network (“SAN”), an internet small computer systems interface (“iSCSI”) SAN, a Fiber Channel SAN, a common Internet File System (“CIFS”), network attached storage (“NAS”), a network file system (“NFS”), optical based storage, or other computer accessible storage. Electronic Storage 140 and 150 can also be used for backup or archival purposes.

In some embodiments, clients 110A-110N and 120A-110N, and server 130 can be, for example, smart phones, tablet devices, PDAs, desktop computers, laptop computers, servers, other computers, or other devices coupled via a wireless or wired connection to network 160. Clients 110A-110N and 120A-110N, and 130 can receive data from user input, a database, a file, a web service, and/or an application programming interface.

Server 130 can be an application server, a backup platform, an archival platform, a media server, an email server, a document management platform, an enterprise search server, a combination of one or more of the foregoing, or another platform communicatively coupled to network 160. Server 130 can utilize one or more of electronic storage 140 and 150 for the storage of application data, backup data, or other data. Server 130 can be a host, such as an application server, which can process data traveling between clients 110A-110N and 120A-110N, and other devices communicatively coupled to network 160. In some embodiments, electronic storage 140 and 150 can store personalized electronic education material, learning profile data (e.g., learning profile classifiers), educational statistics, student grades, student test results, one or more algorithms for generating requests for crowdsourced personalized electronic educational material, one or more algorithms for reviewing personalized educational material, one or more algorithms for rating personalized education material, promotional data, tutor data, other student data, and/or other education data. In some embodiments, server 130 may be a combination of distributed cloud-based storage and dedicated data servers capable of interaction with third-party storage facilities. In this way, the servers may be capable of communication through application program interfaces (“API”) such that the data is ultimately presented to a user through the system server.

In some embodiments, server 130 can be a platform used for receiving personalized electronic education material, and/or generating personalized educational material.

Server 130 can also work with various types of systems that are configured to display educational material to students. For example, the server 130 can provide an interface that receives a request for a specific type of explanation in a specific format (e.g., a request for educational material corresponding to a certain concept, concept portion and/or concept learning profile). Continuing the example, server 130 can support a web site requesting a puzzle associated with a concept, multiple choice questions focused on the concept and explanatory text discussing the concept. Server 130 may also include standardized learning assessment material for assessing a user's mastery, or deficiency, of a concept, as explained in further detail below. The standardized learning assessment material may be supplied from standardized testing agencies, such as the SAT or ACT and associated mock exams, or may be sourced from tests used by each educators or school districts. In addition, standardized learning assessment materials may be sourced from submissions by content curators or tutors or from commercial or other assessment companies.

Learning material (e.g., submitted explanations and/or verified explanations) can be accessible to students in a variety of formats. Clients 110A-110N and 120A-120N can function as electronic textbooks and can be instantly searchable. This can allow a student to find a particular concept they are interested in as well as a corresponding personalized electronic explanation. In some embodiments, Clients 110A-110N and 120A-120N can access material stored locally and network access may not be required. For example, educational material can be periodically downloaded to the Clients 110A-110N and 120A-120N. According to some embodiments, Clients 110A-110N and 120A-120N can access some material stored remotely and network access can be required.

In some embodiments, students can have access to online tutoring. For example, a student having difficulty understanding an explanation can easily and instantly be able to go into a personalized, anonymous, and safe, one-on-one, tutoring center (e.g., hosted by server 130 and presented one or more of clients 110A-110N and 120A-110N). A student can receive prompting, information, or reminders based on a test score or other grading or information can be presented in response to a query. A student can be matched-up with a qualified and ranked tutor automatically based on the student's CLP™ learning profile. Tutoring and coordination to set-up tutoring can be accomplished via crowdsourcing, for example, using e-mail, videoconference, on-line chat, a VOIP based phone call, a social media site (e.g., Facebook™, Twitter™, a proprietary network), or other means. Tutors and students can be evaluated by each other. According to some embodiments, evaluations can be on a grade scale of A to F. Tutors can also be ranked based on subsequent testing of the tutored student on associated educational material. This subjective ranking along with the objective results of the subsequent success or failure by the student to master relevant electronic education material can be used in making future assignments for both the student and the tutor. In some embodiments, evaluations of tutors can be published when the tutor's evaluation exceeds a threshold (e.g., a “B” grade). This ranking can be used to reward successful students and their successful tutors.

For example, tutors can be ranked/measured by: speed with which their students learn, percentage of students who get the answer right the first time after tutoring or with the fewest iterations, and/or happiness rankings from students. In addition, the system may also track a “lateral mastery” determinant (also referred to as a “longitudinal” determinant) to quantify the efficacy of a tutor's instruction to facilitate mastery of future concepts. For example, a student's mastery of an introductory concept such as addition and subtraction is necessary before a student can serve a pre-algebra equation for a specified variable “x.” If a tutor's explanation is very successful at teaching the concept of addition and subtraction, but does not provide sufficient mastery of the concept such that a student struggles to understand how that knowledge translates to a pre-algebra problem. This tutor would receive a low lateral mastery determinant for his or her explanation. Conversely, an explanation with a high lateral mastery determinant would not only ensure that the student masters addition and subtraction, but also establishes a fundamental understanding that enables the student to extrapolate his or her understanding to a pre-algebra problem. The lateral mastery determinant may be informed by the time needed for a student to master a subsequent concept among the variables described above. The lateral mastery determinant also ensures that a tutor is not tailoring his or her explanation to the assessment questions to be used following the explanation. This can be completed using syntax-based machine recognition, for example, to determine if the tutor's instruction is using the same word choice as the ultimate assessment. Typically, different questions and answers are used so that tutors cannot give the answers away or “teach to the test” to gain higher rankings. By the same token, curators can be ranked/measured by: the speed with which they curate, and/or the accuracy of curation (e.g., false rejections, false approvals). Typically, the system also includes a statistically valid way for other curators in the crowd to double check some of the curations with ties being ruled on by a third curation. For example, the system may identify a curator based on the concept and concept learning profile in order to determine a sample size of curators in relation to the overall number of curators. For example, if the number of total curators totals 500, a sample size of curators to double check the curations may total 50, randomly sampled using simple random sample, cluster sampling, convenience sampling, or other sampling methods.

In some embodiments, tutors can be rewarded for the success of their students and student evaluations. Recognition can be on a progressive scale starting with listings, then proceeding to certificates, publicity, and finally awards. An award can include, for example, cash stipends depending on the grades a tutor receives from his or her students, and the number of students that he or she has helped. This can be weighted by the difficulty of the concepts taught, the supply of tutors for a particular concept and learning profile (e.g., how many teach that concept in that format, language, etc.), and other factors. Such recognition can be of great help to highly-ranked tutors when they apply to college or graduate school or teaching positions.

In addition to rewards and recognition for tutors, students can also receive awards and recognition. Recognition can be in the form of online recognition, framed certificates, ribbons, merit badges, trophies, credits, points, levels, access to online educational games, qualification for online educational contests, and other incentives. In some embodiments, parents, guardians, students, and/or schools can approve educational news releases about students that are provided to local media (e.g., a student's or a school's local newspapers or radio stations). A student can have access to a list that provides a summary of educational concepts that a student has learned. The student can filter the list by grade level, date range, subject area, associated tutor, associated teacher, corresponding syllabus subjects, or other criteria. A student can also be able to sort the list. A listing of education concepts learned can be used to provide student rankings (e.g., brown belt, black belt, etc.) which can be general, for a grade level, and/or in a subject area. A listing of educational concepts successfully completed by a student can also be used to provide recommendations of additional educational concepts, eligibility for scholarships, qualification for internships, qualification for recommendations, eligibility to tutor certain subject areas, and other benefits.

Development of incentives, such as games, fun educational facts, or other awards can also be crowdsourced. Requests for educational games, fun facts, or other educational incentives for certain subjects, concepts, and/or learning profiles can be posted to a website, requested via email, or otherwise electronically crowdsourced. Received incentives can be screened, tested, approved, and rated. Screening of the incentives may include using semantic-based machine filtering to identify specific words or phrases for prohibited content. The testing and/or approval of incentives may be achieved by associating the incentive with a desired behavioral outcome that the incentive is intended to elicit. The system may then determine if the reward results in the behavior desired, also common referred to as “behavioral economics.” For example, a monetary award of a lower value may ultimately result in an increased number of attempts by a student, whereas an increased monetary award may result in a decreased number of attempts even though the incentive value is quantitatively higher. Additionally, experiential rewards may be better suited to motivate a learner with a particular concept learning profile. Incentives can be rated by popularity based on incentive recipient feedback or the number of requests for a particular incentive. More popular incentives can require greater educational achievement to obtain. For example, more popular games can require review and successful testing on a higher number of explanations than a less demanded incentive.

By crowdsourcing electronic educational materials, targeting the materials by learning profile, and reducing and/or eliminating the need for manual review and processing of educational materials, several benefits can be realized. Educational materials can be provided to a far greater number of people, and to more different types of people, educational materials can be made available in a wider range of subject areas, the cost of educational materials can be significantly lowered, educational materials can be more effective based on teaching styles being matched to a learning profile, and educational materials can be refreshed more frequently.

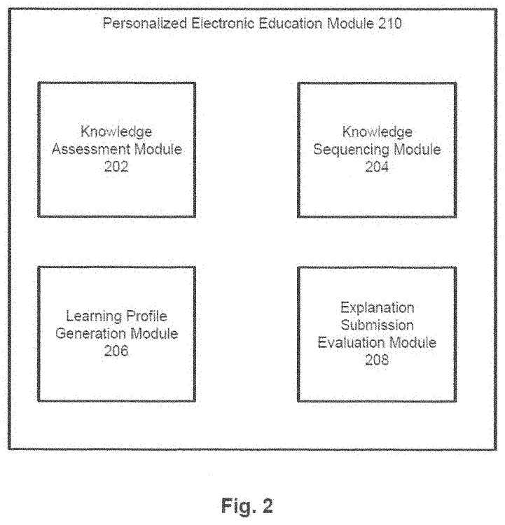

Referring to FIG. 2, a personalized electronic education module 210 is shown. As illustrated, the personalized electronic education module 210 includes knowledge assessment module 202, knowledge sequencing module 204, learning profile generation module 206, explanation submission evaluation module 208, and explanation request module 210. The personalized electronic education module 210 is exemplary, and can include more modules and/or certain described modules can be omitted. One or more modules of FIG. 2 can be implemented on server 130, one or more of clients 110A-110N, one or more of clients 120A-120N, or a combination of the foregoing.

The description below describes network elements, computers, and/or components of a system and method for generating personalized electronic education material that can include one or more modules. As used herein, the term “module” is used to refer to computing software, firmware, hardware, and/or various combinations thereof. Modules, however, are not to be interpreted as software that is not implemented on hardware, firmware, or recorded on a non-transitory processor readable recordable storage medium (i.e., modules are not software per se). It is noted that the modules are exemplary. The modules can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

Knowledge assessment module 202 can evaluate a student's (or even a teacher's) level of knowledge prior to presenting electronic educational material such as a submitted explanation or verified explanation. According to one or more embodiments, pre-testing can be performed to determine a student's level of knowledge prior to presenting explanations. For example, there can be a short, multiple-choice test to test a student's “knowledge-deficit” with respect to a particular concept. That is, the student may already know this concept or may require a pre-requisite learning concept. In other embodiments, the pre-testing may incorporate a larger summative assessment for a specific subject matter, covering many different concepts, with individual questions in the assessment to correspond with more discrete concepts within the subject matter. In this way, the pre-testing may serve to establish a student's baseline conceptual understanding. This baseline conceptual understanding may be evaluated and stored as a component of the student's learning profile, described below. If a student does not understand a concept, it can be useful for the student to recognize what he or she does not know so that it will be appreciated later. Also, determining a student's understanding of a concept and whether the student learned the subject from the educational material presented to the student or if the student knew it already can be accomplished based upon comparing the pre-test results and the student's assessment following an explanation. For example, a pre-test can have one or two multiple-choice questions each with four multiple-choice answers, three of which are wrong answers, but each of which would appear to be the correct answer if the student had a particular typical misunderstanding of the solution to this particular problem. This process can take advantage of the fact that there are typical misunderstandings or wrong “forks in the road” where people who do not understand a problem generally go wrong. In some embodiments, pre-test questions are associated with the same CLP as the learner, which also matches the CLP associated with the explanation. In these embodiments, by assigning the pre-test question based on the CLP, the system controls for variables of the pre-test outcome that may otherwise negatively impact the correlation between the users' learning deficit and the appropriately defined CLP. Similarly, this confirms that any wrong answers are focused on the specific understanding of the concept and not ancillary variables. For example, assigning a pre-test for mathematics based on the user's reading comprehension ability will ensure that any wrong answer is not due to the user's lack of vocabulary and truly reflects the student's lack of understanding of the mathematic concept. In some embodiments, pre-tests may be organized by concept, but include a CLP identifier, such that the system can retrieve at least one question based on the learner's CLP once the system requests an assessment. This process can also be used over time to track the student's progression towards mastery of a concept. Knowledge assessment module 202 can provide an indicator of a student's prior knowledge of a concept when subsequently rating electronic education materials for that concept.

Also part of the personalized electronic education module 210, knowledge sequencing module 204 can synchronize presentation of electronic education materials based on alignment with a student's syllabus, a student's prior knowledge, a student's learning profile, and other factors. Specifically, knowledge sequencing module 204 may be communicably connected to the server 130, student data 155, and explanation data 150 shown in FIG. 1, to recognize related concepts, organized by subject matter or relevant knowledge characteristics. For example, knowledge sequencing module 204 can suggest or require the mastering of all non-tested and passed pre-requisite learning concepts prior to presenting an education concept. In other embodiments, knowledge sequencing module 204 may be organized based on a syllabus, curricula or standards provided by a school district or standards-drafting organization to identify properly organized concepts that build on previous knowledge. Knowledge sequencing module 204 can also evaluate one or more test results or grades to identify subsequent learning concepts for a particular student to learn. The assessment questions will be separately evaluated to ensure that they are effectively reflecting a student's knowledge. In some embodiments, this can also include an additional step of asking the students about how they feel about the explanation and the assessment. In order to automatically evaluate assessment questions, in alignment with the appropriate concept learning profile, the server may implement machine learning or semantic language identification methods to identify the appropriate sequence of concepts. The organization of the knowledge sequencing module 204 may be informed by the data structures of the knowledge base of explanation data 150 to identify correlations or relationships between concepts.

Learning profile generation module 206 can receive, generate, request, and/or detect learning profiles for students. Student learning profiles can indicate, for example, a student's background, cultural preference, language, chronological age, academic age, gap in knowledge, contextual experiences, interests, ability-to-learn, desire-to-learn, favorite style of learning, and currently remembered and mentally-accessible prior knowledge. In some embodiments, the learning profile may also include genetic information determined using DNA analysis to help identify aspects of a learner's and a tester's concept learning profile. A student's learning profile can also include a student's favored or most successful method or style of learning (e.g., reading, viewing, listening, cartoons, graphics, text, diagrams, tactile, audible, analogies, pictures, videos, demonstrations, etc.). Student learning profiles can further include other indicators used to tailor electronic educational material development and delivery. Specifically, a user's learning profile may be distinct for different concepts or subject matters, representing a specified concept learning profile, that reflects differing strengths and opportunities for students based on the character or substance of the relevant concept. For example, a user may have one concept learning profile with respect to learning fundamental music theory concepts based on his or her background and geographic location whereas that same user may have a different concept learning profile with respect to learning fundamental scientific principles that accounts for the fact that he or she attends an experiential-based learning, science-focused elementary school. In this way, the learning profile may be further focused to account for specific characteristic variables.

Although a student can initially select a student learning profile based on preference, learning profile generation module 206 can learn over time what is effective for that particular student (e.g., based on one or more test results associated with material presented to a student). Learning profile generation module 206 can periodically suggest to the student an updated learning profile, discussed in further detail below. Learning profile generation module 206 can offer a pre-test to help each student initially to identify which learning profiles likely will work best to help that particular student with respect to each subject area. As described above, this pre-test may take multiple forms including, for example, a small number of focused, concept-based questions or a preliminary summative assessment related to the subject matter at a user's designated grade level, among others. In addition, learning profile generation module 206 may assign a confidence interval to a user's concept learning profiles based on the length of time that the user has been engaging with the platform, the number of concept learning variable determinants or variables that align with a specific concept learning profile, or even empirically-based on structured tests that are proven to determine a user's learning modality, all of which strengthen the likelihood that a user's concept learning profile is properly identified. The confidence interval may be calculated as a function of the user's use history (e.g., length of time), test result as a function of the explanation CLP, percentage of correct responses, frequency of repeated use of the platform, and/or quantitative measure of the student's pleasure with the system, among others. The confidence interval may take into account CLPs adjacent to the user's currently assigned CLP based on closely correlated variables within different CLPs. In order to calculate the confidence interval, the system may weigh the variables equally or evaluate weighted averages as determined by a subject matter expert. In some embodiments, the server may implement machine learning or semantic language identification methods to account for additional variables, or relationships between variables in calculating the confidence interval.

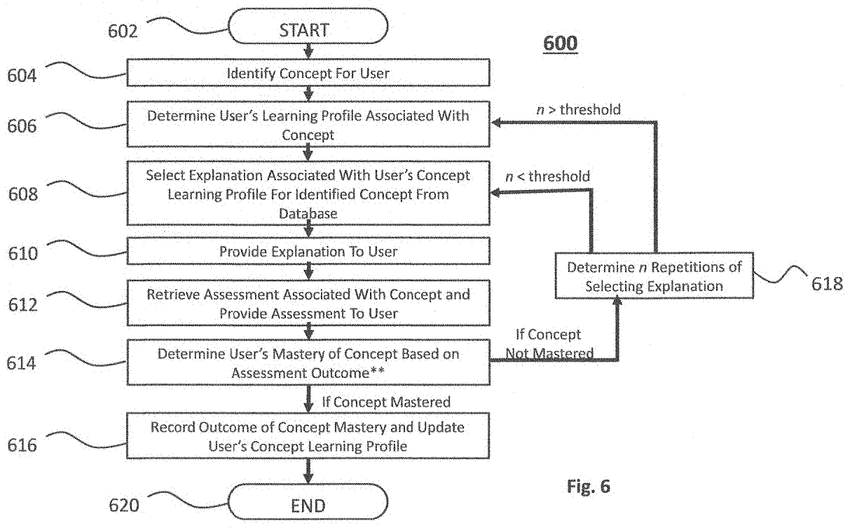

Learning profiles can be classified broadly and can be adjusted based on testing results, administration preferences, teacher preferences, student preferences, or other factors. For example, learning profiles can be based generally on a grade level or chronological age and can be refined based on data indicating different learning styles and levels of success with different types of educational materials, described below in connection with FIG. 6. In some embodiments, a user's concept learning profile, and associated explanation, may account for the user's mental dexterity, which represents the ability for a user to quickly understand new concepts or subject matters. In some embodiments, the number of available learning profiles can be limited to a predefined number (e.g., 500). It can be more effective to have a limited number of learning profiles that all students are “mapped” to rather than having each student assigned a unique learning profile. The number of learning profiles can be a represented by the topology of a multi-dimensional data matrix representing the characteristics within any one learning profile. The identifying data about the user may be stored in a multi-dimensional data matrix, such that the individual fields of the data matrix correspond with the characteristics of the user, such as a preferred cultural background of the student, a level of interest of the student in a subject, a known familiar context of the student, an ability of the student to learn new concepts in a particular discipline, a favored style of learning of the student, a chronological age of the student, the student's zip code, and an academic age of the student, among others. As explained further below, the presence of characteristics within particular data fields of the learning profile data matrix may be used to identify appropriately matched explanations, or even similar learning profiles, that may best benefit the user. In addition, the learning profile data matrix may include associated metadata expressing the strength of a correlation between adjacent variables. For example, a positive correlation between the student's zip code and favored learning style of the student. In some embodiments, key characteristics to be stored within the learning profile data matrix can be parsed from publicly available information available about the student, or information gathered from associated social media accounts. The learning profile data matrix metadata may further inform a confidence interval associated with the learning profile, describe further below. For example, it may be better to assign a student a learning profile that matches the student 90%, and have fewer learning profiles to develop educational material for, than to have a learning profile that fits a student 100%, but have a potentially infinite number of learning profiles to develop educational material for. As described above, the fit of a user's learning profile may be indicated by the confidence interval based on the variables within his or her profile.

Although a student can initially select a student learning profile based on preference, learning profile generation module 206 can learn over time what learning profile is most effective for that particular student (e.g., based on one or more test results associated with material presented to a student) at that point in their life and for that particular subject area, such as music, social studies, and/or math. A student's learning profile may, and likely will, change over time. Learning profile generation module 206 can periodically suggest to our system an updated learning profile or concept learning profile. Learning profile generation module 206 can also offer a pre-test to help each student initially to identify which learning profile likely will work best to help that particular student at that moment in the student's life and for that particular subject area.

Learning profile generation module 206 can periodically reevaluate learning profiles of students, either following individual concept learning opportunities or larger, summative assessments of a user's knowledge development. Electronic storage can store statistics, for example the quantitative variables previously identified in confidence interval calculations, relating to what types of electronic explanations work well for each particular learning profile and what each student has learned so far (e.g., electronic storage 140 and/or 150 of FIG. 1). Each subsequent electronic explanation presented to a student can be iteratively improved to match the best and latest learning profile for that particular, individual student.

Explanation submission evaluation module 208 can receive submitted explanations. Explanations can be received via one or more electronic transmissions including, but not limited to: e-mails, HTTP transmissions, FTP transmissions, SMS messages, etc. Submitted explanations can be parsed, filtered for prohibited terms (e.g., profanity or ethnic or social bias), screened for required concept terms, scored, ranked, spell checked, or otherwise processed. Received electronic educational materials can be iteratively processed, screened, modified, tested, and/or selected. This processing may occur using machine learning platforms or database services such as distributed cloud-based storage and dedicated data servers capable of interaction with third-party storage facilities. In this way, the servers may be capable of communication through application program interfaces (“API”) such that the data is ultimately presented to a user through the system server. For example, the explanation submission evaluation module 208 can receive an e-mail containing educational information relating to calculus, which is then screened and scored before it is made available to students. The submitted, and thus automatically vetted explanations can then be presented in a blind manner to students as was described above, and/or can be manually vetted by the crowd before being submitted to a statistically valid sample of like learning profile students for testing to see which explanation is the best for students with that learning profile. Submitted explanations can be categorized by concept, concept portion, and/or learning profile. Similar to assessment material, in some embodiments, explanations may be organized by concept, but include a CLP identifier, such that the system can retrieve at least one question based on the learner's CLP once the system requests an assessment. Submitted explanations can be iteratively automatically or manually processed, screened, modified, tested, and/or selected for the ultimate goal of arriving at a verified explanation that can be presented to students with confidence. According to one or more embodiments, submitted explanations can be received, processed, and submitted for testing without human intervention.

Explanation submission evaluation module 208 can also receive submitted explanations from, for example, students, the public, and/or another predetermined group of people stored as part of Explanation Data Server 150. Submitted explanations can include material from third-party sources. A submitter does not have to be the author of the material, but proper attribution should be provided by a submitter if they are not the author. For example, so that a submitter still can receive credit for a submission. An original author can receive credit as well. For example, a submitter can submit online educational material from a well-known educational institution and can properly indicate the source of the material (e.g., Joe Q. Public submits a link to an on-line Harvard University lecture). Permission to use a submitted explanation for which authorship is or is not attributed to the submitter can be verified prior to use. Original authors can also receive credit, incentives, rewards, and/or compensation.

Explanation submission evaluation module 208 can automatically check submitted explanations for, for example, accuracy, ease of understanding, completeness, and lack of ambiguity. For example, in some embodiments, explanation submission evaluation module 208 can be provided with a set of keywords, phrases, formulas, facts, or other criteria to search for in a submitted explanation for a concept. In order to automatically categorize a submission, in alignment with the appropriate concept learning profile, the server may implement machine learning or semantic language identification methods to identify, for example, the submission language, grade level, subject matter, zip code associated with the submitter or other identifiable variables based on the substance of the submission. Presence or absence of the criteria can provide a first level of vetting or curating of a submitted explanation. The identifying data from the submitted explanation may be stored in mutli-dimensional data matrix, such that the individual fields of the data matrix correspond with the characteristics of the submission, such as the identified subject matter, concept, intended language, intended grade level, and characteristics associated with the submitter's profile. As explained further below, the presence of characteristics within particular data fields of the explanation data matrix may be used to identify appropriately matched learning profiles that may best benefit from the specific explanation. In addition, the explanation data matrix may include associated metadata expressing the strength of a correlation between adjacent variables. For example, a positive correlation between the intended concept and learning modality, like explaining chemistry using videos that show a chemical reaction, may be monitored and stored. In some embodiments, key concept terms and synonyms for key concept terms can be parsed from a syllabus, lesson plan, or other education schedule that a submitted explanation is to be synchronized with as part of a learning sequence, the placement within the learning sequence being a field in the data matrix. According to some embodiments, a person requesting, submitting, or curating an explanation can provide a set of criteria for a first level of vetting of submitted explanations including, for example, 1) what concept the explanation is explaining, and 2) who the likely user may be based on concept learning profile characteristics or variables.

According to some embodiments, submitted explanations can also be reviewed by experts in a field or subject matter area of a concept. Submitted explanations can be electronically provided to one or more certified curators for the subject matter area of a concept (e.g., posted to a secured website or a distributed via a limited mailing list.) Crowdsourcing of curation of submitted explanations can allow submitted explanations to be reviewed by a wider range of people including a wider range of languages and cultures. This can allow explanations to be provided for a greater number of people, a greater range of student demographic backgrounds, and a greater range of learning profiles. Edited and/or revised submitted explanations can be received by explanation submission evaluation module 208. According to some embodiments, submitted explanations can be rejected and/or returned to a submitter after a review by a certified curator with a request for clarification or other edits.

Submitted explanations can be tested by a sample group of test students prior to being presented to a larger group of students. Testing can present submitted explanations as a blind extra (or third) explanation to a small but statistically significant number of students within the same or adjacent concept learning profiles to test that submitted explanation against a current standard (or “Control” or “Postulate Explanation”) for a particular concept to be learned by students with the same target concept learning profile. In some embodiments, the comparison of submitted explanations may represent a comparison between individually, similarly focused explanations based on the efficacy of the explanation as measured by the successful mastery of the concept by users. In this way, the evaluation of explanation submissions operates like that used to evaluate the effectiveness of tutors previously described herein. By comparing individual explanations for the same concept learning profile one-by-one, the system is able to determine, and rank, the best explanations iteratively to guarantee that the explanations elevated as most helpful within the system are truly the most effective explanation. In some embodiments, the system may require that an explanation repeat a specified number of testing rounds before being made available to the live system and provisioned to students.

The postulate explanation can be a vetted or certified explanation that has been reviewed by experts, proven successful based on prior student test scores (possibly including the time required for students to learn a concept), proven popular with students, and/or authored by an established expert for the learning concept. Students who unknowingly are testing unproven explanations also can get additional certified explanations to ensure that a student is not limited to an uncertified explanation.

To avoid test bias, the presentation order of the contending unproven submitted explanation and the currently high-ranking certified explanation (the “control”) can be randomly alternated from student to student. Less well performing explanations (new or old) can be abandoned in a selection process that allows more successful explanations to succeed. Even certified or vetted explanations can be periodically reevaluated and/or ranked against other explanations. Testing can be random, immediate, or automatically scheduled and conducted. For example, submitted explanations can be presented to a set of test students automatically by sending an electronic invitation, calendar notification, email, or other communication. The communication can contain a link to an online test. Questions associated with the submitted explanations can be incorporated into an online test together with control questions. The questions can be provided by a submitter of the explanation being tested or by another submitter.

For each explanation, percentages of students who comprehend a concept within various time frames or within various numbers of reviews of the material can be tracked and associated with the explanation. This can indicate which explanations seem to be the easiest and/or quickest to understand with respect to each concept or concept portion and learning profile, which concepts are difficult, what prerequisites are required and how the syllabus might be re-ordered to eliminate gaps and/or to be more easily understood by a student with the defined concept learning profile. Test results of a submitted explanation can be published (e.g., without student identifying information) so that electronic education contributors and/or authors can identify areas of greatest need, and/or study what types of explanations work best, and for which learning profiles. Ratings and/or feedback relating to the electronic education materials can be provided by students to allow identification of electronic education materials that require improvement and/or electronic education materials that are well liked. Ratings and/or feedback can be provided, for example, electronically via a provided website, in response to an email, in response to questions provided after an explanation, or via more traditional survey or questionnaire methods. Based on this feedback, explanations for a specific concept learning profile can be assigned a confidence interval, similar to that assigned to the user's concept learning profiles, based on the length of time that the submitter has been engaging with the platform, the number of concept learning variable determinants or variables that align with a specific concept learning profile, professional accolades associated with the submitter's profile, or other determinants, all of which strengthen the likelihood that a submission is of high quality and likely to provide a valuable explanation to a user. Similar to the confidence intervals for a user's learning profile, the confidence interval may be calculated as a function of student's test result as a function of the user's CLP, percentage of correct responses following the explanation, frequency of repeated use of within the system, and/or quantitative measure of the student's pleasure with the explanation, among others. The confidence interval may take into account CLPs adjacent to the current explanation based on closely correlated variables within different CLPs. In this way, an explanation may be associated with multiple CLP variables such that it can apply to multiple users. For example, an explanation that is helpful for an advanced fifth grade student may also be useful for a sixth grade student that has struggled with a particular concept. In order to calculate the confidence interval, the system may weigh the variables equally or evaluate weighted averages as determined by a subject matter expert. In some embodiments, the server may implement machine learning or semantic language identification methods to account for additional variables, or relationships between variables in calculating the confidence interval.

In some embodiments, several, or any number of submitted explanations for the same topic (or even different topics) can be compared against one another to determine which one is best for a given student and/or learning profile (e.g., certain submitted explanations may be suitable for visual learners, but not hands-on learners). For example, several submitted explanations (or verified explanations) for a particular concept can be presented to a group of students. The students can have the same learning profile and/or different learning profiles. The students can then be tested on that concept (e.g., as described in the previous paragraph), and the explanation submission evaluation module 208 can track how effective each respective explanation was in educating the student. By tracking this information, the explanations can be ranked against one another. The ability to measure the extent to which one explanation is better than all others for a particular concept and learning profile can be determined by many factors such as the number of explanations competing to explain a particular concept for students with a particular learning profile, and/or the number of students testing each explanation, and/or the difference in measurable results between one explanation and its closest competitor. As explained above, a confidence interval rating can be assigned to each verified explanation to indicate how likely it is that the explanation is indeed the best for that concept and that learning profile

Submitted explanations that fail to facilitate student understanding and passage of a subsequent test can automatically be discarded in favor of explanations that have been proven by previous students' test scores to work better (e.g., an explanation scores higher for a particular concept and learning profile). Explanation submission evaluation module 208 can measure and rank the time that it takes a student to get the correct answer after first seeing an explanation. Additionally, even if the student correctly and quickly answers a test based on an explanation, the student can rate the explanation. Ratings can include whether it was fun and easy to learn, or confusing, tedious or otherwise irritating. Rating systems can include, for example, three “thumbs-up,” or two “thumbs-down,” numerical rankings, and/or other indicators. The ranking process can facilitate selection of the best explanations for each concept in each learning profile, an understanding of which learning profiles work best for each student for each of their subjects. This can allow subsequent automatic offerings of explanations that are targeted to students with the same learning profiles.

In some embodiments, a concept can be taught using explanations from multiple different contributors. For example, explanation submission evaluation module 208 can receive text and diagrams from a first contributor for a particular concept and can receive testing material and answers from a second contributor for the same concept. Explanation submission evaluation module 208 can combine the contributions from the various sources to create a single assessment made up of multiple individual explanation materials stored within the system. Also, explanations, questions, and answers associated with a single concept and a single learning profile can each be obtained from separate submitters. Although a particular submitter may provide a best explanation, a second submitter may provide better questions to test understanding, and a third submitter may provide the best answers to the questions to test understanding. Questions and answers can be evaluated separately in a manner similar to explanations (e.g., based on blind testing as described above with respect to evaluating the efficacy of submitted explanations).

Explanation submission evaluation module 208 can also rank explanations based on their fit within a learning profile for a student (e.g., a student's background, cultural preference, language, chronological age, academic age, gap in knowledge, contextual experiences, interests, ability-to-learn, desire-to-learn, favorite style of learning, currently remembered and mentally-accessible prior knowledge, and a student's favored or most successful method or style of learning).

Explanation request module 210 can request electronic education materials by posting on a website, sending e-mails, tweeting, sending Short Message Service (SMS) messages, and/or via other electronic transmission mediums. One or more templates for requests, algorithms for generating requests, student learning profiles, and other electronic education request material can be retrieved by explanation request module 210 from electronic storage (e.g., electronic storage 140 and/or 150 of FIG. 1). For example, the explanation request module 210 can post a request on a webpage asking for subject matter experts in the area of calculus to submit educational materials relating to specific calculus concepts and specific learning profiles.

In some embodiments, explanation request module 210 can be used to transmit requests for electronic education materials. For example, explanation request module 210 can be a web server or an application server posting or transmitting a request to the public for personalized educational material explaining an educational concept (e.g., server 130 of FIG. 1). The educational material request can be directed to the public at large, or to a predetermined group. The educational material request can also specify a targeted learning profile, format guidelines or requirements, desired subject matter coverage, required subject matter coverage or other details. Requested electronic educational material can include information for synchronization with a study plan, syllabus, or other educational schedule of a student or group of students. For example, concepts can be broken into one or more portions so as to synchronize with a class lesson plan or to be easier to understand.

Requested electronic educational materials can also be targeted by a student learning profile or even concept learning profile.

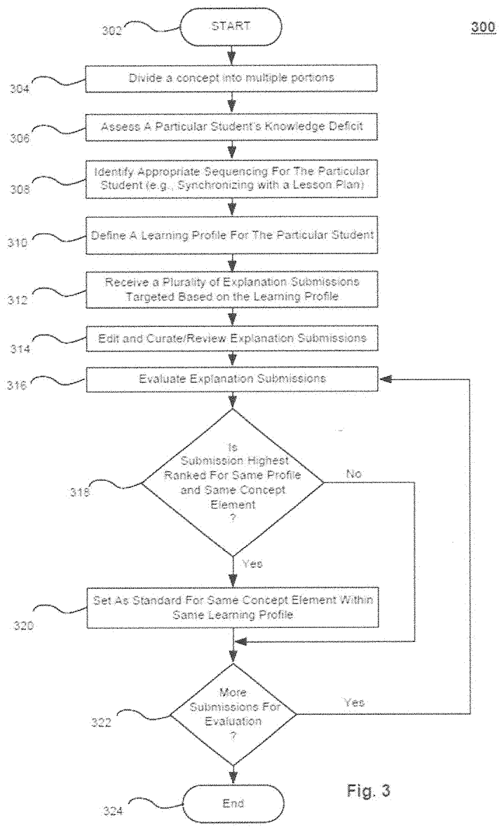

In operation, referring to FIG. 3, with further reference to FIGS. 1-2, a method 300 for generating and evaluating personalized education using the system 100 can include the stages shown. The method 300, however, is exemplary only and not limiting. The process 300 can be altered, e.g., by having stages added, changed, removed, or rearranged.

At stage 302, the method 300 can begin.

At stage 304, a learning concept can be divided into multiple portions. This can be based on organization of a learning concept found in a student's syllabus or other determination as described above. Division of a learning concept can also be performed to allow introduction of prerequisite material prior to one or more portions, or to match a learning profile of a student. For example, if a student is being taught calculus, the concepts can be broken down such that a student is first taught differential calculus and then integral calculus, and each of those concepts can be broken down into further sub-units of information, and so on, until a concept is no longer sensibly divisible for effective learning.

At stage 306, a particular student's learning deficit can be assessed. For example, knowledge assessment module 202 of FIG. 2 can assess a student's learning deficit by delivering a pre-test to establish a student's existing knowledge of a concept. A student can also be presented with a series of questions that have difficulty levels ranging from basic to advanced. In addition, the students can also be presented with questions that are designed to probe specific areas of the student's knowledge. For example, a student can be tested to ensure that the student has a solid understanding of trigonometry before the student begins to learn calculus.

At stage 308, appropriate sequencing for a particular student can be determined. For example, knowledge sequencing module 204 of FIG. 2 can determine sequencing of educational material. This can allow electronic education material for that student to follow a lesson plan or syllabus for the student, which can be identified based on the variables within the students learning profile, such as geographic location, to determine the appropriate sequence of concepts associated with a school district. In other embodiments, the system may determine a sequence of concepts based on research-based intellectual sequence development that may differ from a local school district curriculum (e.g., an International Baccalaureate curriculum). It can also allow introduction of additional preparation materials, review, tutoring, or additional related student interest areas. For example, based upon the student's knowledge level or learning profile, the sequencing of a lesson presented to the student can be modified (e.g., the student is taught trigonometry before being taught calculus). This information, gleaned from a student's concept learning profile, informs the knowledge sequencing module 204's determination of the appropriate lessons to provide to the student.

At stage 310, a learning profile can be defined for a student. For example, learning profile generation module 206 of FIG. 2 can define a student's learning profile and/or concept learning profile. Student concept learning profiles can indicate, for example, a student's background, cultural preference, language, chronological age, academic age, subject related gaps in knowledge, contextual experiences, interests, ability-to-learn, desire-to-learn, favorite style of learning, and currently remembered and mentally-accessible prior knowledge. In this way, the concept learning profile may represent a similar matrix data structure of the user's learning profile, however, including additional data fields accounting for the difference characteristics of a user with respect to the individual concept. This additional information may include addition of a new column or row of associated information in the data matrix, or modifying the existing fields of a user's learning profile to account for concept as indicated within data matrix metadata. Student concept learning profiles can also include a student's favored or most successful method or profile of learning (e.g., reading, viewing, listening, cartoons, graphics, text, diagrams, tactile, audible, analogies, pictures, videos, demonstrations, etc.). Student concept learning profiles can further include other indicators used to tailor electronic educational material development and delivery. According to some embodiments, a pre-test can be used to initially identify which learning profiles can work best to help a particular student in each subject area. Additionally, as described further below, the user's concept learning profile may be adaptively modified following successful or unsuccessful mastery of concepts.

At stage 312, submissions including educational materials can be received. The submissions and/or educational material can be targeted to a student's learning profile, or be generic for use with a large group of students. Submissions can be received via one or more electronic transmissions including, but not limited to: e-mails, HTTP transmissions, FTP transmissions, SMS messages, etc. For example, subject matter experts can view a student's individualized lesson plan, and provide educational materials targeted for that particular student.

At stage 314, received submissions can be edited and reviewed to, for example, parse and/or filter the submitted explanations for prohibited terms (e.g., profanity). For example, explanation submission evaluation module 208 of FIG. 2 can receive and process submissions. The received submissions can also be screened for required concept terms, scored, ranked, spell checked, or otherwise processed. The processing performed on the received submissions can also be iterative (e.g., iteratively processed, screened, modified, tested, and/or selected). Also, within stage 314, after forms of prescreening explanations, it can further presort explanations into proper concepts and associate the explanations with specific concept learning profiles based on the aspects of the explanation such as type of instruction, level of practice, whether the explanation is practice or lecture-based, and other variables.

At stage 316, received submissions including education materials can be further evaluated. For example, explanation submission evaluation module 208 of FIG. 2 can evaluate and rate submissions. The received submissions can be tested by a sample group of like-CLP test students prior to being presented to a larger group of students. Testing can present electronic education submissions as a blind extra (or third) explanation to a small but statistically significant number of students, to test that explanation against a current standard (or “Control”) for a particular concept to be learned by students who share a particular set of learning styles and/or learning profile. Testing can be automatically scheduled and conducted based on the recognition of the knowledge assessment module and the knowledge sequence module previously described. For example, electronic education submissions can be presented to a set of test students. Questions associated with the electronic education submissions can be incorporated into an online test together with control questions. For each explanation, a percentage of students from the same or similar concept learning profiles who comprehend a concept within a specified time frame or within a specified number of reviews of the material can be tracked. This can indicate which concepts are difficult, what prerequisites are required, and how the syllabus might be re-ordered to eliminate gaps and/or to be more intuitive.

At block 318, the process 300 determines if a received submission is ranked the highest for teaching students with a particular set of learning profiles a learning concept or portion of a learning concept. If a submission is ranked the highest for teaching students with a particular learning profile a learning concept, or portion of a learning concept, the method continues to stage 320. Otherwise, the method 300 continues to stage 322.

At stage 320, a highest ranked submission can be set as a standard for teaching a particular learning concept or portion of a learning concept to students with particular set of learning profiles. A highest ranked submission can become a control explanation for evaluation of other explanations.

At stage 322, the method 300 determines whether more submissions are to be evaluated. If more submissions are to be evaluated, the method 300 returns to block 316, otherwise the process proceeds to stage 324.

At stage 324, the method 300 can end, if desired. Method 300 may also be repeated.

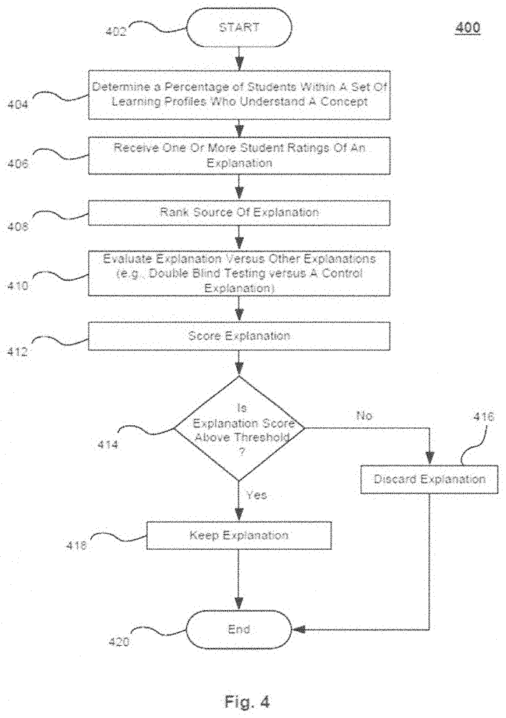

In operation, referring to FIG. 4, with further reference to FIGS. 1-2, a method 400 for evaluating personalized education using the system 100 includes the stages shown. The method 400, however, is exemplary only and not limiting. The method 400 can be altered, e.g., by having stages added, removed, changed, or rearranged According to one or more embodiments, explanation submission evaluation module 208 of FIG. 2 can perform processing associated with one or more of the stages shown in FIG. 4. In some embodiments, portions of processing can be performed on a client side (e.g., clients 110A-110N and 120A-120N of FIG. 1) or one or more other modules.

At stage 402, the method 400 can begin.

At stage 404, a percentage of students within a particular learning profile who understand a concept can be measured. For example, in order to do so, test results associated with explanations can be evaluated. For each explanation a percentage of students who comprehend a concept within a specified time frame or within a specified number of reviews of the material can be tracked. This can indicate which concepts are difficult, what prerequisites are required, and how the syllabus might be re-ordered to eliminate gaps and/or to be more intuitive.

At stage 406, one or more student reviews can be received. The reviews can include ratings that relate to one or more different quantifiable and/or subjective aspects of the educational material. For example, ratings can include whether it was fun and easy to learn, or confusing, tedious or otherwise irritating. Rating systems can include, for example, three “thumbs-up,” or two “thumbs-down,” numerical rankings, and/or other indicators. This rating process can facilitate selection of explanations as well as determination of what categories, in general, of explanations seem to work best for each type of specific student. This can allow automatic offering of subsequent categories of explanations that are tailored to a particular student.

At stage 408, a source of a certified explanation can be evaluated. This can be based on student ratings for an explanation being evaluated, how much better this particular explanation scored compared to the second best explanation or second place winner, how scarce explanations are for that particular concept and learning profile, how many best or certified explanations that particular author has submitted, ratings of a plurality of explanations written by the source, reviews of the source, or other factors.

At stage 410, testing can present submitted explanations as a blind extra (or third) explanation to a small but statistically significant number of students, to test that explanation against a current standard (or “Control”) for a particular concept to be learned by students who share a learning profile. Testing can be automatically scheduled and conducted. For example, submitted explanations can be presented to a set of test students. Questions associated with the submitted explanations can be incorporated into an online test together with control questions.

At stage 412, an explanation can be scored based on test results, source evaluations, student evaluations, and other factors. In some embodiments, explanations may be sorted by associated concept learning profile and tested by a statistically significant number of students (e.g., within one standard deviation) with identical CLP's as previously described. The characteristics used to determine the strength or efficacy of an explanation may include which explanation was understood by the largest percentage of testers, which explanation was the quickest to be understood as evidenced by mastery of students following the explanation, which explanation was the most fun as rated by students after completing the explanation, and which explanation provides the strongest foundation for later-taught concepts (i.e., a “lateral” or “longitudinal” score).

At stage 414, it can be determined whether the score for an explanation is above a specified threshold. Similar to the determination of a tutor's success described above, the score for the explanation may be based on the speed with which their students learn, percentage of students who get the answer right the first time after completing the explanation or with the fewest iterations, and/or satisfaction ratings from students. In addition, the system may also track a “lateral mastery” determinant (also referred to as a “longitudinal” determinant) to quantify the efficacy of an explanation to facilitate mastery of future concepts. If the score for an explanation is above a specified threshold, the method continues to stage 418. Otherwise, the method proceeds to stage 416.

At stage 416, explanations that do not have a score above the threshold can be discarded, stored, and/or marked for further evaluation or refinement.

At stage 418, an explanation with a score above a specified threshold can be saved as a certified explanation for future use. According to some embodiments, prior to certifying an explanation against a current best explanation for a particular concept and learning profile, the explanation can be reviewed by specified experts for the subject matter of the concept. In addition, the system may evaluate a confidence interval associated with the current best explanation to determine whether to replace it with a new explanation, using the same calculations previously described.

At block 420, the method 400 can end.

In some embodiments, the system can be configured to guard against submitters of explanations, consciously or unconsciously, forcing or biasing students towards the correct answer, thus making it appear that their questions, answers, and/or explanations are better than they really are (thus consequently causing their explanation to outperform the other explanations against which it is competing). For example, this could occur if the submitter “teaches to the test,” and/or writes questions and answers in such a way that most students naturally would pick the correct answer, even when they do not fully understand the concept. As one method of guarding against submitters from gaming the system by submitting biased questions and answers, the questions and answers can also be tested in the same way as is each submitted explanation (e.g., by crowdsourcing the questions and answers to be tested).

For example, to maintain high quality, effective questions and answers (e.g., used to test a student's knowledge level), the system can be configured to: i) use questions and answers derived independently of the submitter for each concept and learning profile, ii) use different, statistically valid, randomly assigned, “non-paired” questions and answers for each concept and learning profile in order to statistically identify testing aberrations introduced by poor questions and/or answers, and iii) use crowdsourced volunteers to randomly check some or all winning verified explanations to ensure that the questions and answers are of high quality. “Non-paired” in this context means that the system can be configured to split-up each question and its supplied three wrong and one right answers, and then take the now free-floating question and these now free-floating answers and randomly mix and match them with other free-floating questions and other free-floating answers in different combinations (but typically only for the same concept and the same learning profile).

In some embodiments the system can also be configured to guard against students selecting the correct answer by chance or with help from others (e.g., by identifying students whose recurring test results suggest guessing or receiving from others correct answers).

In some embodiments, teachers and school districts can insert their own questions and answers for any concept and learning profile, or specify which “standard” test questions and answers a teacher or school board wants to be used for their students. Teacher-written and industry-standard questions and answers can also be tested to see if some should be used on a more widespread basis.

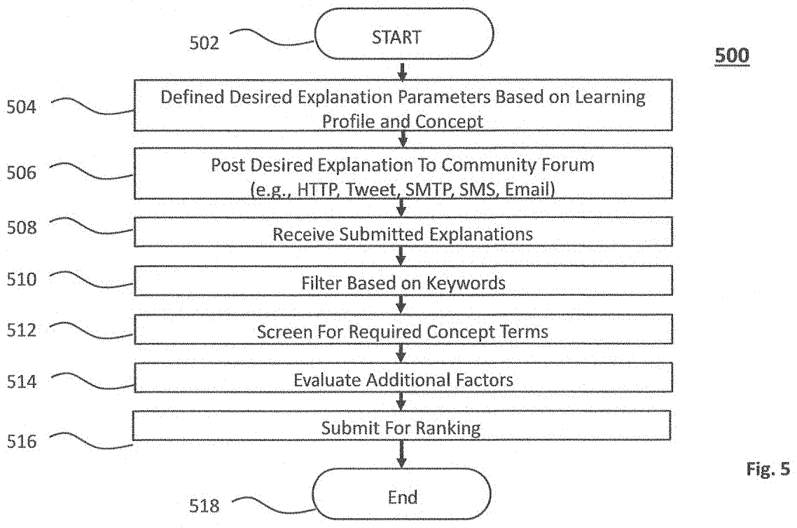

In operation, referring to FIG. 5, with further reference to FIGS. 1-2, a method 500 for requesting and pre-processing of submissions for personalized education using the system 100 includes the stages shown. The method 500, however, is exemplary only and not limiting. The method 500 can be altered, e.g., by having stages added, removed, changed, or rearranged. According to one or more embodiments, explanation request module 210 of FIG. 2 can perform processing associated with one or more of the stages shown in FIG. 5. According to one or more embodiments, explanation submission evaluation module 208 of FIG. 2 can perform processing associated with one or more of the stages shown in FIG. 5. In some embodiments, portions of processing can be performed on a client side (e.g., clients 110A-110N and 120A-120N of FIG. 1) or one or more other modules.

At stage 502, the method 500 can begin.

At stage 504, parameters of a desired submission can be defined. For example, a desired submission can be electronic educational material drafted to explain a particular concept for a particular learning profile. Parameters can include elements and key terms of a concept that should be covered. A lesson plan or other curriculum can be parsed to identify key terms of a concept. Elements of a concept learning profile can be extracted to identify a target audience for the desired submission. For example, learning profile concepts specified can include: prior knowledge of the student, a preferred language of the student, a preferred cultural background of the student, a level of interest of the student in a subject, a known familiar context of the student, an ability of the student to learn new concepts in a particular discipline, a favored style of learning of the student, a chronological age of the student, and an academic age of the student. In some embodiments, a user's concept learning profile, and associated explanation, may account for the user's mental dexterity, which represents the ability for a user to quickly understand new concepts or subject matters. According to one or more embodiments, explanation submission evaluation module 208 of FIG. 2 can provide a user interface for receiving and transmitting requested explanation parameters.

At stage 506, a request for a desired explanation can be submitted. Explanations can be requested via one or more electronic transmissions including, but not limited to: e-mails, HTTP transmissions, FTP transmissions, tweets, SMS messages, etc. Posting of a desired explanation can provide crowdsourcing of the explanation generation.

At stage 508, submissions including educational materials can be received. The submissions and/or educational material can be targeted to a student's learning profile, or be generic for use with a large group of students. Submissions can be received via one or more electronic transmissions including, but not limited to: e-mails, HTTP transmissions, FTP transmissions, SMS messages, etc. For example, subject matter experts can view a student's individualized lesson plan, and provide educational materials targeted for that particular student.

At stages 510, 512 and 514, received submissions can be edited and reviewed to, for example, parse and/or filter the submitted explanations for prohibited terms (e.g., profanity). For example, explanation submission evaluation module 208 of FIG. 2 can receive and process submissions. The received submissions can also be screened for required concept terms, scored, ranked, spell checked, or otherwise processed. The processing performed on the received submissions can also be iterative (e.g., iteratively processed, screened, modified, tested, and/or selected). Additional factors can include considerations such as a number of explanations for a particular concept and a particular learning profile. For example, if a preferred language has only one explanation for a concept it is far less likely that such an explanation would be filtered out.

At stage 516, a submitted explanation can be submitted for ranking. As described above in reference to FIG. 4., ranking can include testing by a control group of students.

Referring to FIG. 6, in further reference to FIGS. 1 and 2, a method for providing a computer implemented personalized education system and adjust an adaptive concept learning profile begins at stage 602, whereby a user may access the personalized electronic education module and begin the process for learning a concept. At stage 604, the knowledge sequencing module may identify a concept related to the user's learning profile that is part of the sequence of learning. In some embodiments, the system may present a concept to the user without requiring a choice by the user (i.e., an assigned curriculum), while in other embodiments the user may be able to select a concept that he or she is interested in. The concept may be related to an academic topic that the student is learning in school (e.g., calculus, world history, biology, etc.). The concept may be directed to a non-academic topic the student is interested in learning (e.g., financial planning, etc.). Following selection of a concept, at stage 606, the user's learning profile and associated concept learning profile is determined to accurately reflect the user's characteristics, as described above using the learning profile data matrix. In some embodiments, for example when a user's concept learning profile is not fully formed, the system may present a user with a preliminary assessment associated with the identified concept from stage 604 and determine the user's concept learning profile at that instant. In other embodiments, a preliminary assessment may be used to identify a specific deficit in the user's understanding related to the selected concept, the outcome of which may be stored as a field in the user's concept learning profile data matrix. In yet other embodiments, the system may determine that the user's concept learning profile is properly defined based on a sufficient response in the preliminary assessment and continue to stage 616 for recording the user's mastery of the concept.

At stage 608, once the system identifies the user's concept learning profile, the system may select an explanation associated with the user's concept learning profile for the selected concept, as organized in the explanations database 150. In this way, the system may provide the highest-ranked explanation for the identified concept and concept learning profile, having been determined using the process described above. In some embodiments, an explanation that is highest-ranked for an identified concept may be the highest-ranked explanation for multiple similar concept learning profiles. To determine the relationship between the user's concept learning profile and concept learning profile associated with the explanation, the system may determine the number of similar data fields within the user's concept learning profile data matrix and the explanation data matrix. In some cases, the determination may require a specific match between the relevant data fields, however, in other embodiments the system may only require a relationship between a subset of data fields, or specifically weighted data fields. At stage 610, the system provides the explanation to the user, through the user's client device, and allows the user to view and/or interact with the proffered explanation. After completing the explanation, at stage 612, the user is presented with an assessment associated with the concept. The assessment provided to the user may be a single question or a series of questions, depending on the quality of the assessment material as determined as a function of the outside sources from which the question or questions was sourced and the confidence that the student's answers to that assessment truly reflect the concept that was part of the explanation. The assessment provided to the user may be selected based on one or more characteristics identified within the user's learning profile data matrix. At stage 614, the system evaluates the outcome of the assessment to determine whether a student has mastered the concept. In addition to this determination, in some embodiments, the system may query for direct feedback from the student about his or her understanding of the concept in order to evaluate the effectiveness of the explanation he or she received at stage 610.

Following stage 614, if a user has mastered the concept, the system continues to stage 616 where the outcome of the assessment is recorded in a database associated the user's concept learning profile, and the user's concept learning profile data matrix is updated to account for the newly mastered concept. In some embodiments, mastery of a concept at stage 614 may also include a notification as described above to the user's family, friends, or other interested individuals to indicate that the user has mastered the concept. In yet other embodiments, the system may also provide additional positive reinforcement mechanisms such as rewards, experiences related to the concept they learn, or offering the student an opportunity to serve as a tutor to students having the same concept learning profile as a tutor.

Alternatively, following stage 614, if a user has not mastered the concept, the system may provide additional assessment material to the student to determine whether the student has or has not mastered the concept. If a user has not mastered the concept, the system will revert to determine the source of the user's misunderstanding, whether it be the explanation provided or the designation of the concept learning profile. At stage 618, the system will determine the number of times, “n,” that the student has attempted mastery of the concept selected at stage 604. The number of times relevant to stage 618 may be determined by the system operator in order to effectively modify a user's explanations and concept learning profile in accordance with the present disclosure, such that exceeding the threshold number of repetitions indicates that the student's concept learning profile should be adapted by the system. Adaptation of the user's concept learning profile may include modifying the individual data fields of the concept learning profile data matrix or the metadata associated therewith. In some embodiments, the number “n” may be dictated based on the confidence interval associated with the student's concept learning profile such that, for example, if a user's concept learning profile bears a high confidence interval such that the assignment of the concept learning profile is likely accurate, then the number of repetitions required may be high as well. If the student did not master the concept, but the attempted explanations is less than the set threshold value, the system will revert to stage 608 and identify a new explanation associated with the user's concept learning profile in a supplemental attempt to teach the user the concept. In some embodiments, the system will seek out the explanations at stage 608 based on the ranking of the explanations described above. The system will continue this procedure until the student either masters the concept or reaches the threshold value “n” attempts.

If the user is unable to master the concept within the number of threshold attempts, the system may revert to stage 606 and adjust the user's concept learning profile, taking into account the previous failed attempts to master the selected concept. Thereafter, the system repeats stages 608 through 616 until the student masters the selected concept. In this way, the system provides an adaptive concept learning profile generator that factors in the students most-recent successes or failures.

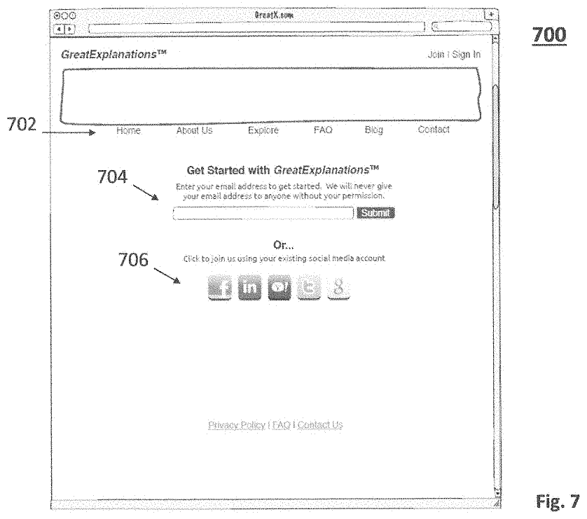

FIG. 7 illustrates an exemplary user interface for a user to create a user profile, according to some embodiments of the disclosure. User interface 700 includes a heading toolbar 702, which includes the website portions for “home,” “about us,” “explore,” frequently asked questions or “FAQ,” “blog,” and “contact.” Each of the individual elements of the heading toolbar 702 may include additional information related to the service provider, the user's profile information, and/or links to external resources for the user's information. User interface 700 also includes an information input portion 704 whereby as user may enter his or her email address to begin the process of creating a learner profile, as described above. Alternatively, a user may create his or her learner profile by selecting an associated social media account through social media account link 706. As described above, in this way a user may connect his or her learner profile to social media accounts such as Facebook, LinkedIn, Yahoo email, Twitter, Google, or other social media sites.

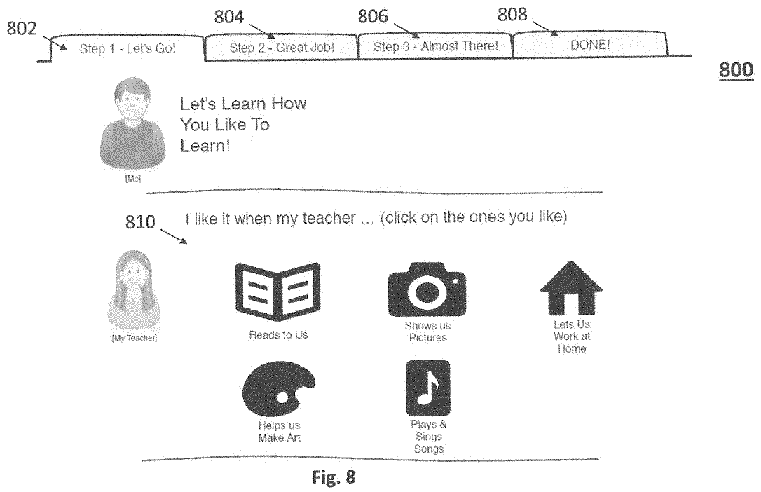

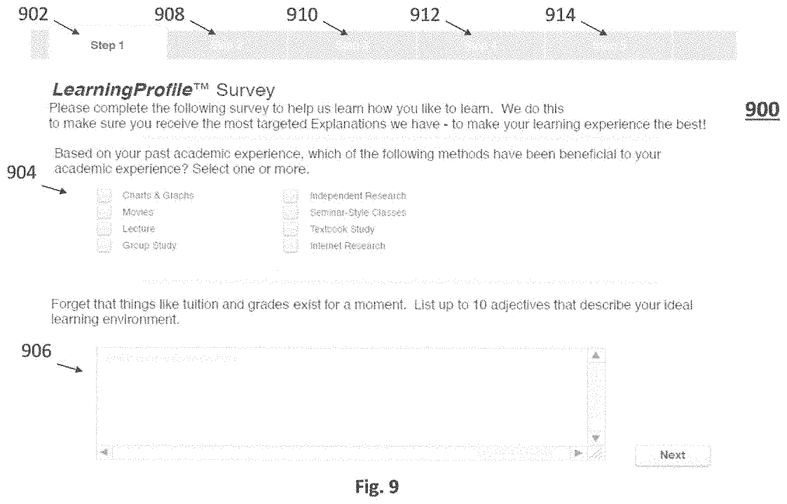

FIGS. 8 and 9 illustrate exemplary introduction pages for a user for creation of his or her learning profile, according to some embodiments of the present disclosure. Referencing FIG. 8, user interface 800 illustrates an embodiment of a user interface for a younger learner profile, for example a student in upper elementary school. User interface 800 includes individual tabs 802, 804, 806, 808 within the user interface representing the sequential steps to complete the users learner profile. At each step in the process, represented by tabs 802, 804, 806, 808 the user provides additional information to the system regarding his or her preferences and characteristics, as described above, to complete the user profile. Within tab 802, a user may be asked to identify his or her preferred learning methodology, indicated by preference portion 810 that presents the user with preferred activities to learn new concepts. In addition to the preferred learning methodology, tab 802 may include inputs for the user's preferred subject matter, time of day to learn new concepts, cultural background, and primary language, among others. In some embodiments each of the variables to establish the user's learner profile may be presented as part of tabs 804, 806, and/or 808.

Referencing FIG. 9, user interface 900 illustrates an embodiment of a user interface for an advanced learner profile, for example a student at a university or adult learner. User interface 900 includes individual tabs 902, 908, 910, 912, 914 within the user interface representing the sequential steps to complete the user's learner profile. At each step in the process, represented by tabs 902, 908, 910, 912, 914 the user provides additional information to the system regarding his or her preferences and characteristics, as described above, to complete the user profile. Within tab 902, a user may be asked to identify his or her preferred learning methodology, indicated by preference portion 904 that presents the user with preferred methodologies to learn new concepts. In addition to the preferred learning methodology, tab 902 may include an input portion 906 for the user to provide a written description of his or her learning style. In some embodiments, as described above, the system may employ syntax-based machine determinants to associate the user's input with learning profile categories for individual concepts. In addition, tab 902 or subsequent tabs 908, 910, 912, 914 may include inputs for the user's preferred subject matter, time of day to learn new concepts, cultural background, and primary language, among others. In some embodiments each of the variables to establish the user's learner profile may be presented as part of tabs 908, 910, 912, and/or 914.

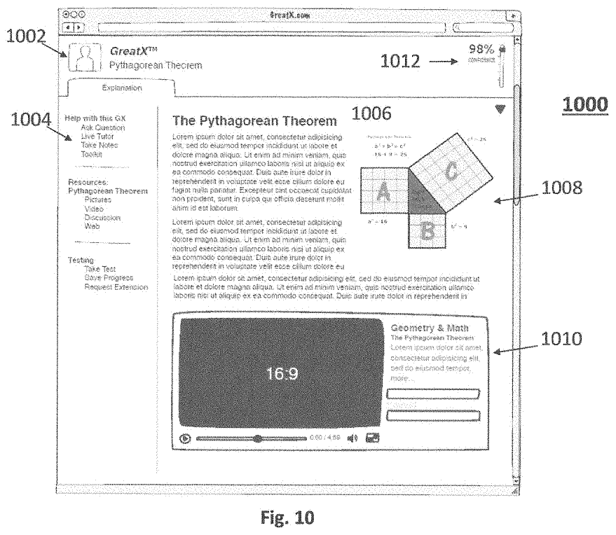

FIG. 10 illustrates an exemplary explanation page presented to a user based on his or her learning profile, according to some embodiments of the present disclosure. User interface 1000 includes a concept identifier 1002, a toolbar 1004, explanation 1006, graphics 1008, video 1010, and confidence rating 1012. The concept identifier 1002 may include user's profile identifying information, such as an image, and the title of the concept being presented in the explanation. Toolbar 1004 may include a help section including links to tutors, as previously described, or note-taking functions, as well as additional resources related to the concept such as pictures, videos, discussion or external weblinks and assessment materials. Explanation 1006, retrieved from the explanation data 150 described above, may include a text description of the concept and discussion materials provided by a submission, as previous described. Explanation 1006 may further include graphics 1008 to illustrate the concept in the explanation and/or a video 1010 intended to supplement the explanation 1006. In some embodiments, the inclusion of graphics 1008 and video 1010 within explanation 1006 may represent a combination of multiple explanations curated for the user's concept learning profile as described above. In other embodiments, explanation 1006 may include each of graphics 1008 and video 1010 as the pre-defined explanation associated with the user's concept learning profile. Confidence rating 1012 may be included to illustrate the confidence rating of the explanation 1006 strength and/or the confidence of the system that the explanation 1006 provided to the user is adequately matched to his or her concept learning profile.

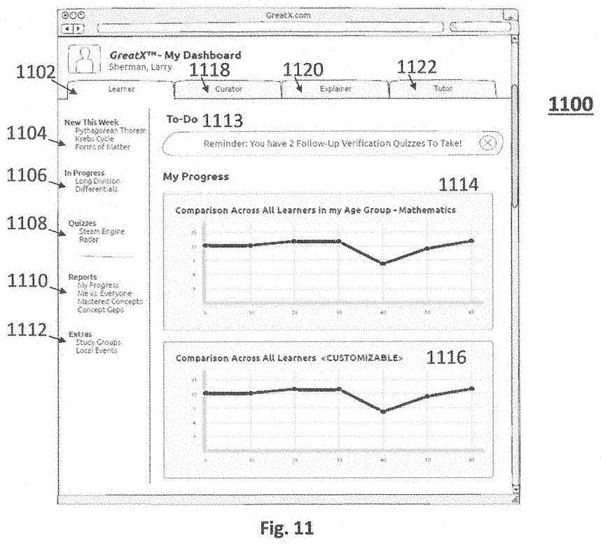

FIG. 11 illustrates an exemplary user interface for presenting an adaptive concept learning profile for a user, according to some embodiments of the present disclosure. User interface 1100 includes learner tab 1102 to display new concepts 1104, in progress concepts 1106, assessments 1108, reports 1110, extras 1112, and progress graphs 1114, 1116. User interface 1100 also may include curator tab 1118, explainer tab 1120, and tutor tab 1122 associated with the additional aspects of the user's profile. In some embodiments, the user profile may include multiple aspects as a learner, curator, explainer, and/or tutor, each of which is previously described. In such embodiments, the user may select between the different roles as part of user interface 1100.

Learner tab 1102 includes new concepts 1104 to present the user with additional concepts for mastery as part of the concepts sequence, as defined above, or potentially new concepts that the user may be interested in based on his or her concept learning profile. For example, as shown in FIG. 11, the user's concept learning profile and associated sequence may require that he or she attempt to master the Pythagorean theorem in mathematics, the Krebs cycle as part of chemistry, and forms of matter as part of lessons in biology. In progress concepts 1106, additionally, may list the concepts that the user has yet to master, through the process described in connection with FIG. 6, or that the user must spend more time with before completing an assessment. In progress concepts 1106 may also be represented as part of notifications 1113, marked as a “To Do” for the user. For example, as illustrated in FIG. 11, this may include long division or differentials. Assessments 1108 may include the upcoming assessments for the user, including both pre-assessment and mastery assessments following completion of an explanation. Similar to the in progress concepts 1106, assessments 1108 may be listed as part of notifications 1113. Reports 1110 may include multiple reports to track the user's learning progress and/or adaptations as employed by the system described above, including a comparison between the user and other peer users, a tracker of mastered concepts, and a tracker for “concept gaps” identifying the user's learning deficit. These reports may take the form of progress graphs 1114 and 1116, providing a graphical illustration of the user's progress with respect to a concept, subject, or learning concept profile. Extras 1112, included as part of user interface 1100 may present the user with links or opportunities for study groups or local events related to the user's concept learning profile or curriculum sequence as assigned by the system.

While the description discusses “concepts,” the techniques described herein can also be used with subjects and/or concept portions.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other input devices can be included, such as a virtual keyboard or a key pad created on a touch screen, a joystick, a stylus, and a pen. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Further, while the description above refers to the invention, the description may include more than one invention.

1. A computer-implemented method for implementing on-line learning, the method comprising:
determining, by a processor, a concept from a set of stored concepts within a server based on a concept identifier from a sequence of concept identifiers associated with a curriculum template, the concept associated with a first explanation entry data matrix, the first explanation entry data matrix including a plurality of data fields populated with characteristics of a first explanation and the concept;
retrieving, by the processor, a learning profile from a set of stored learning profiles using a learning profile data matrix, the learning profile associated with the first explanation entry data matrix based on a correlation between the learning profile data matrix and the first explanation entry data matrix, the learning profile data matrix including the concept identifier from the sequence of concept identifiers associated with the curriculum template;
associating, within a server, a plurality of users associated with the learning profile data matrix based on a correlation metric between the concept identifier of the first explanation entry and the learner profile indicated by the relative position of the data fields within the first explanation entry data matrix and the learning profile data matrix;
assigning the plurality of users automatically to at least two test groups including a postulate explanation group and a hypothesis group;
providing remote access to the first explanation to the postulate explanation group via a first plurality of client devices;
retrieving an assessment from an assessment data server associated with the concept based on the concept identifier stored as part of assessment metadata, the assessment including at least one probative question directed to the concept identifier;
providing the assessment for completion to the postulate explanation group via a second output on the plurality of client devices and automatically generating a postulate group outcome for the assessment indicated by a first percentage of correct responses to the assessment;
determining, by the processor, a second explanation entry data matrix for a second explanation entry associated with the concept based on the concept identifier;
providing remote access to the second explanation entry to the hypothesis group via a second plurality of client devices;
providing the assessment for completion to the postulate explanation group via a second output on the plurality of client devices and determining a hypothesis group outcome for the assessment indicated by a second percentage of correct responses to the assessment;
comparing the results of the assessment outcomes indicated by the first percentage and the second percentage to calculate a success metric indicating a relative strength of the first explanation as compared to the second explanation and storing the success metric as part of the first explanation entry data matrix.

2. The method of claim 1, further including ranking the first explanation and second explanation in an explanation database based on the success metric.

3. The method of claim 1, further including identifying one of the first explanation and the second explanation as a preferred explanation for the learning profile based on the success metric.

4. The method of claim 1, wherein the success metric includes a confidence interval based on a number of times that the first explanation has been assigned to the postulate explanation group.

5. The method of claim 1, wherein at least one of the plurality of learning profiles includes information indicative of the characteristics, including at least one of:
prior knowledge of at least one of the plurality of users;
a preferred language of at least one of the plurality of users;
a preferred cultural background of at least one of the plurality of users;
a level of interest of at least one of the plurality of users in a subject;
a known familiar context of at least one of the plurality of users;
an ability of at least one of the plurality of users to learn new concepts in a particular discipline;
a favored style of learning of at least one of the plurality of users;
a chronological age of at least one of the plurality of users; and
an academic age of at least one of the plurality of users.

6. The method of claim 1, wherein performing the assessment of at least one of the plurality of students includes at least one of:
identifying a priori knowledge for the set of concepts;
identifying gaps in a priori knowledge of the at least one of the plurality of students associated with the set of concepts; and
supplementing explanation information to address identified knowledge deficits.

7. The method of claim 1, wherein the concept identifier represents a categorical determination selected by a submitter.

8. A computing device for implementing online learning, the computing device comprising:
a memory capable of storing a concept learning profile data template that includes a data template sequence; and
a processor in communication with the memory, configured to read the adaptive concept learning profile data template stored in the memory and cause the processor to:
determine, by a processor, a concept from a set of stored concepts within a server based on a concept identifier from a sequence of concept identifiers associated with a curriculum template, the concept associated with a first explanation entry data matrix, the first explanation entry data matrix including a plurality of data fields populated with characteristics of a first explanation and the concept;
retrieve, by the processor, a learning profile from a set of stored learning profiles using a learning profile data matrix, the learning profile associated with the first explanation entry data matrix based on a correlation between the learning profile data matrix and the first explanation entry data matrix, the learning profile data matrix including the concept identifier from the sequence of concept identifiers associated with the curriculum template;
associate, within a server, a plurality of users associated with the learning profile data matrix based on a correlation metric between the concept identifier of the first explanation entry and the learner profile indicated by the relative position of the data fields within the first explanation entry data matrix and the learning profile data matrix;
assign the plurality of users automatically to at least two test groups including a postulate explanation group and a hypothesis group;
provide remote access to the first explanation to the postulate explanation group via a first plurality of client devices;
retrieve an assessment from an assessment data server associated with the concept based on the concept identifier stored as part of assessment metadata, the assessment including at least one probative question directed to the concept identifier;
provide the assessment for completion to the postulate explanation group via a second output on the plurality of client devices and automatically generating a postulate group outcome for the assessment indicated by a first percentage of correct responses to the assessment;
determine, by the processor, a second explanation entry data matrix for a second explanation entry associated with the concept based on the concept identifier;
provide remote access to the second explanation entry to the hypothesis group via a second plurality of client devices;
provide the assessment for completion to the postulate explanation group via a second output on the plurality of client devices and determining a hypothesis group outcome for the assessment indicated by a second percentage of correct responses to the assessment;
compare the results of the assessment outcomes indicated by the first percentage and the second percentage to calculate a success metric indicating a relative strength of the first explanation as compared to the second explanation and store the success metric as part of the first explanation entry data matrix.

9. The system of claim 8, wherein the processor is further configured to rank the first explanation and second explanation in an explanation database based on the success metric.

10. The system of claim 8, wherein the processor is further configured to include identifying one of the first explanation and the second explanation as a preferred explanation for the learning profile based on the success metric.

11. The system of claim 8, wherein the success metric includes a confidence interval based on a number of times that the first explanation has been assigned to the postulate explanation group.

12. The system of claim 8, wherein at least one of the plurality of learning profiles includes information indicative of the characteristics, including at least one of:
prior knowledge of at least one of the plurality of users;
a preferred language of at least one of the plurality of users;
a preferred cultural background of at least one of the plurality of users;
a level of interest of at least one of the plurality of users in a subject;
a known familiar context of at least one of the plurality of users;
an ability of at least one of the plurality of users to learn new concepts in a particular discipline;
a favored style of learning of at least one of the plurality of users;
a chronological age of at least one of the plurality of users; and
an academic age of at least one of the plurality of users.

13. The system of claim 8, wherein performing the assessment of at least one of the plurality of students includes at least one of:
identifying a priori knowledge for the set of concepts;
identifying gaps in a priori knowledge of the at least one of the plurality of students associated with the set of concepts; and
supplementing explanation information to address identified knowledge deficits.

14. The system of claim 8, wherein the concept identifier represents a categorical determination selected by a submitter.
